(19) United States
(12) Patent Application Publication
(10) Pub. No.: US 2023/0202245 A1
(43) Pub. Date: Jun. 29, 2023

(54) PNEUMATIC TIRE

(71) Applicant: The Yokohama Rubber Co., LTD., Tokyo (JP)

(72) Inventors: Masahiro NARUSE, Kanagawa (JP); Yuki NAGAHASHI, Kanagawa (JP)

(21) Appl. No.: 17/999,667

(22) PCT Filed: May 11, 2021
(86) PCT No.: PCT/JP2021/017862

§ 371 Date: Nov. 22, 2022

(30) Foreign Application Priority Data
May 28, 2020 (JP) 2020-093569

(51) Int. Cl. B60C 19/00; B60C 13/00

(52) U.S. Cl. CPC B60C 19/00; B60C 13/00

(57) ABSTRACT

In a pneumatic tire including a tread portion extending in a tire circumferential direction and having an annular shape, a pair of sidewall portions respectively disposed on both sides of the tread portion, and a pair of bead portions disposed on an inner side of the pair of sidewall portions in a tire radial direction, a transponder is embedded in one of the sidewall portions extending in the tire circumferential direction, the transponder is covered with a coating layer, a relative dielectric constant of the coating layer is lower than a relative dielectric constant of a peripheral rubber member adjacent to the coating layer, and a shortest distance D from an outer edge of the coating layer to the transponder in a tire meridian cross-section is 0.3 mm or more.

### TECHNICAL FIELD

The present technology relates to a pneumatic tire in which a transponder covered with a coating layer is embedded and particularly relates to a pneumatic tire that can provide improved communication performance of the transponder.

### BACKGROUND ART

For pneumatic tires, embedding an RFID (radio frequency identification) tag (transponder) in a tire has been proposed (see, for example, Japan Unexamined Patent PublicationNo. H07-137510 A). In embedding the transponder in the tire, coating the transponder with a coating layer and lowering the relative dielectric constant of the coating layer allows the communication performance of the transponder to be improved. However, when the covering with the coating layer is insufficient, the communication performance of the transponder may degrade.

### SUMMARY

The present technology provides a pneumatic tire that can provide improved communication performance of a transponder.

A pneumatic tire according to an embodiment of the present technology includes a tread portion extending in a tire circumferential direction and having an annular shape, a pair of sidewall portions respectively disposed on both sides of the tread portion, and a pair of bead portions each disposed on an inner side of the pair of sidewall portions in a tire radial direction. In the pneumatic tire, a transponder is embedded in one of the sidewall portions extending in the tire circumferential direction, the transponder is covered with a coating layer, a relative dielectric constant of the coating layer is lower than a relative dielectric constant of a peripheral rubber member adjacent to the coating layer, and a shortest distance D from an outer edge of the coating layer to the transponder in a tire meridian cross-section is 0.3 mm or more.

According to an embodiment of the present technology, the transponder is covered with the coating layer, the relative dielectric constant of the coating layer is lower than the relative dielectric constant of the peripheral rubber member adjacent to the coating layer, and the shortest distance D from the outer edge of the coating layer to the transponder in the tire meridian cross-section is 0.3 mm or more. Thus, the transponder is sufficiently isolated from the peripheral rubbermember and wrapped with the coating layer having a low relative dielectric constant, allowing the communication performance of the transponder to be improved.

According to an embodiment of the present technology, the total thickness Gac of the coating layer preferably ranges from 1.5 mm to 3.5 mm. This can achieve the effect of improving the communication performance of the transponder and improve the durability of the transponder due to the protective effect based on the coating layer. Further, specifying the upper limit value of the total thickness Gac of the coating layer allows sufficient durability of the tire to be ensured.

Preferably, the transponder includes a substrate and antennas extending from both ends of the substrate and has a distance L between an end of the antennas in the tire circumferential direction and an end of the coating layer in the tire circumferential direction ranges from 2 mm to 20 mm. This reliably covers the entire transponder with the coating layer, allowing a sufficient communication distance of the transponder to be ensured. Furthermore, specifying the upper limit value of the distance L avoids occurrence of a local weight increase on the tire circumference and can satisfactorily maintain a tire balance.

Preferably, the coating layer is made of elastomer or rubber and has a relative dielectric constant of 7 or less. Specifying the relative dielectric constant of the coating layer in this way can effectively improve the communication performance of the transponder.

The center of the transponder is preferably disposed 10 mm or more spaced from a splice portion of a tire component in the tire circumferential direction. This can effectively improve the durability of the tire.

The transponder is preferably disposed between a position of 15 mm outer side in the tire radial direction from an upper end of a bead core of a bead portion and a tire maximum width position. This causes the transponder to be disposed in a region having a reduced stress amplitude during travel, thus allowing the durability of the transponder to be effectively improved and further preventing the communication performance of the transponder and the durability of the tire from being degraded.

### BRIEF DESCRIPTION OF DRAWINGS

FIG. 1 is a meridian cross-sectional view illustrating a pneumatic tire according to an embodiment of the present technology.

FIG. 2 is an enlarged cross-sectional view illustrating a main portion of the pneumatic tire of FIG. 1.

FIGS. 3A and 3B are perspective views each illustrating a transponder that can be embedded in a pneumatic tire according to an embodiment of the present technology.

FIG. 4 is a cross-sectional view illustrating a transponder that is covered with a coating layer and embedded in a pneumatic tire.

FIG. 5 is a meridian cross-sectional view illustrating a modified example of a pneumatic tire according to an embodiment of the present technology.

FIGS. 6A to 6C are plan views each illustrating a transponder that is covered with a coating layer and embedded in a pneumatic tire.

FIGS. 7A and 7B are plan views each illustrating a transponder that is covered with a coating layer and embedded in a pneumatic tire.

FIG. 8 is a meridian cross-sectional view schematically illustrating the pneumatic tire of FIG. 1.

FIG. 9 is an equator line cross-sectional view schematically illustrating the pneumatic tire of FIG. 1.

FIG. 10 is an explanatory diagram illustrating a position of a transponder in a tire radial direction in a test tire.

### DETAILED DESCRIPTION

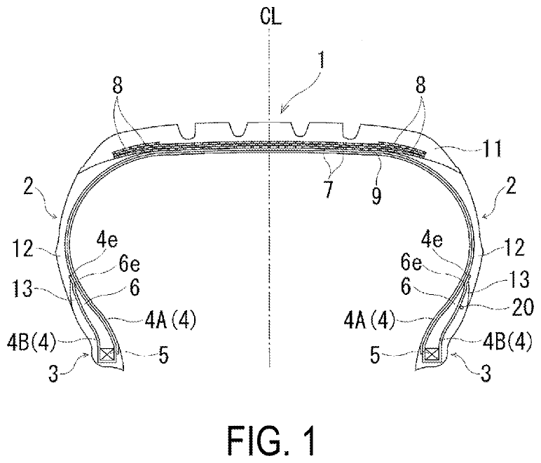

Configurations of embodiments of the present technology will be described in detail below with reference to the accompanying drawings. FIGS. 1 to 7 illustrate a pneumatic tire according to an embodiment of the present technology.

As illustrated in FIG. 1, the pneumatic tire according to the present embodiment includes a tread portion 1 extending in a tire circumferential direction and having an annular shape, a pair of sidewall portions 2 respectively disposed on both sides of the tread portion 1, and a pair of bead portions 3 each disposed on an inner side in a tire radial direction of the pair of sidewall portions 2.

At least one carcass layer 4 (one layer in FIG. 1) formed by arranging a plurality of carcass cords in the radial direction is mounted between the pair of bead portions 3. The carcass layer 4 is covered with rubber. Organic fiber cords of nylon, polyester, or the like are preferably used as the carcass cords constituting the carcass layer 4. Bead cores 5 having an annular shape are embedded within the bead portions 3, and bead fillers 6 made of a rubber composition and having a triangular cross-section are disposed on the outer peripheries of the bead cores 5.

On the other hand, a plurality of belt layers 7 (two layers in FIG. 1) are embedded in a tire outer circumferential side of the carcass layer 4 of the tread portion 1. The belt layers 7 include a plurality of reinforcing cords that are inclined with respect to the tire circumferential direction, and the reinforcing cords are disposed between layers so as to intersect each other. In the belt layers 7, the inclination angle of the reinforcing cords with respect to the tire circumferential direction is set to fall within a range of from 10° to 40°, for example. Steel cords are preferably used as the reinforcing cords of the belt layers 7.

To improve high-speed durability, at least one belt cover layer 8 (two layers in FIG. 1) formed by arranging reinforcing cords at an angle of, for example, 5° or less with respect to the tire circumferential direction is disposed on a tire outer circumferential side of the belt layers 7. In FIG. 1, the belt cover layer 8 located on the inner side in the tire radial direction constitutes a full cover that covers the entire width of the belt layers 7, and the belt cover layer 8 located on an outer side in the tire radial direction constitutes an edge cover layer that covers only end portions of the belt layers 7. Organic fiber cords such as nylon and aramid are preferably used as the reinforcing cords of the belt cover layer 8.

In the pneumatic tire described above, both ends 4e of the carcass layer 4 are folded back from the tire inner side to the tire outer side around the bead cores 5 and are disposed wrapping around the bead cores 5 and the bead fillers 6. The carcass layer 4 includes a body portion 4A corresponding to a portion extending from the tread portion 1 through each of the sidewall portions 2 to each of the bead portions 3 and a turned-up portion 4B corresponding to a portion turned up around the bead core 5 at each of the bead portions 3 and extending toward each sidewall portion 2 side.

Additionally, on a tire inner surface, an innerliner layer 9 is disposed along the carcass layer 4. Furthermore, a cap tread rubber layer 11 is disposed in the tread portion 1, a sidewall rubber layer 12 is disposed in the sidewall portion 2, and a rim cushion rubber layer 13 is disposed in the bead portion 3.

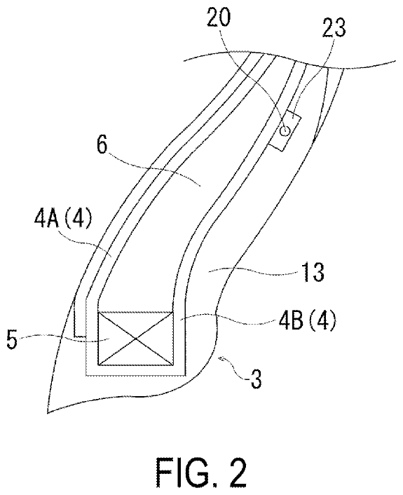

Additionally, in the pneumatic tire described above, the transponder 20 is embedded in a portion of the sidewall portion 2 located on the outer side of the carcass layer 4 in the tire width direction extending in the tire circumferential direction. As illustrated in FIG. 2, the transponder 20 is covered with a coating layer 23. The coating layer 23 coats the entire transponder 20 while holding both front and rear sides of the transponder 20.

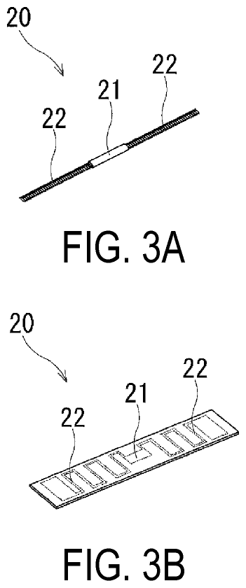

As the transponder 20, for example, a radio frequency identification (RFID) tag can be used. As illustrated in FIGS. 3A and 3B, the transponder 20 includes an IC (integrated circuit) substrate 21 that stores data and antennas 22 that transmits and receives data in a non-contact manner. Using such a transponder 20 allows information related to the tire to be written or read on a timely basis and the tire to be efficiently managed. Note that “RFID” refers to an automatic recognition technology including: a reader/writer including an antenna and a controller; and an ID (identification) tag including an IC substrate and an antenna, the automatic recognition technology allowing data to be communicated in a wireless manner.

The overall shape of the transponder 20 is not particularly limited, and for example, a pillar- or plate-like shape can be used as illustrated in FIGS. 3A and 3B. In particular, using the transponder 20 having a pillar-like shape illustrated in FIG. 3A can suitably follow the deformation of the tire in each direction. In this case, the antenna 22 of the transponder 20 projects from each of both end portions of the IC substrate 21 and exhibits a helical shape. This allows the transponder 20 to follow the deformation of the tire during travel, allowing the durability of the transponder 20 to be improved. Additionally, by appropriately changing the length of the antenna 22, the communication performance can be ensured.

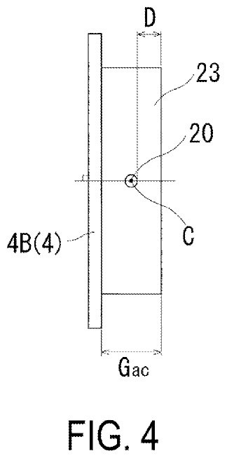

In the pneumatic tire configured as described above, the relative dielectric constant of the coating layer 23 covering the transponder 20 is set to be lower than the relative dielectric constant of the peripheral rubber member adjacent to the coating layer 23 (for example, the bead filler 6, the innerliner layer 9, the sidewall rubber layer 12, the rim cushion rubber layer 13, and the coating rubber of the carcass layer 4). Moreover, as illustrated in FIG. 4, the shortest distance D from the outer edge of the coating layer 23 to the transponder 20 in the tire meridian cross-section is set to be 0.3 mm or more. That is, the transponder 20 is disposed at any position in the coating layer 23 in the tire meridian cross-section, but in any case, the shortest distance D from the outer edge of the coating layer 23 to the transponder 20 is 0.3 mm or more.

In the pneumatic tire described above, the transponder 20 is covered with the coating layer 23, the relative dielectric constant of the coating layer 23 is lower than the relative dielectric constant of the peripheral rubber member adjacent to the coating layer 23, and the shortest distance D from the outer edge of the coating layer 23 to the transponder 20 in the tire meridian cross-section is set to be 0.3 mm or more. Thus, the transponder 20 is sufficiently isolated from the peripheral rubber member and wrapped with the coating layer having a low relative dielectric constant, so that the communication performance of the transponder 20 can be improved. That is, the radio wave wavelength shortens in the dielectric body, and the length of the antenna 22 of the transponder 20 is set to resonate with the shortened radio wave wavelength. Optimizing the length of the antenna 22 of the transponder 20 in this way significantly improves communication efficiency. To optimize the communication environment of the transponder 20, however, the transponder 20 should be sufficiently isolated from the peripheral rubber member adjacent to the coating layer 23. Therefore, by sufficiently ensuring the shortest distance D from the outer edge of the coating layer 23 to the transponder 20, the communication performance of the transponder 20 can be improved.

Here, when the shortest distance D from the outer edge of the coating layer 23 to the transponder 20 in the tire meridian cross-section is smaller than 0.3 mm, the effect of improving the communication performance of the transponder 20 cannot be obtained. In particular, the shortest distance D from the outer edge of the coating layer 23 to the transponder 20 in the tire meridian cross-section preferably ranges from 0.3 mm to 1.0 mm.

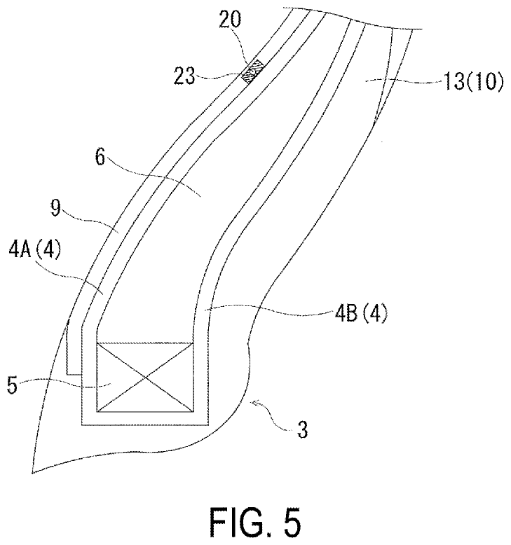

Further, the pneumatic tire described above includes the transponder 20 embedded in the outer side in the tire width direction from the carcass layer 4, and thus there is no tire component blocking radio waves during communication with the transponder 20, allowing the communication performance of the transponder 20 to be satisfactorily ensured. In the present technology, the transponder 20 is disposed on the sidewall portion 2, but the position in the tire axial direction is not limited. In a case where the transponder 20 is embedded in the outer side in the tire width direction from the carcass layer 4, the transponder 20 can be disposed between the turned-up portion 4B of the carcass layer 4 and the rim cushion rubber layer 13, or between the carcass layer 4 and the sidewall rubber layer 12. In another configuration, the transponder 20 can be disposed between the turned-up portion 4B of the carcass layer 4 and the bead filler 6 or between the main body portion 4A of the carcass layer 4 and the bead filler 6. As illustrated in FIG. 5, a transponder 20 may also be disposed between the carcass layer 4 and the innerliner layer 9.

In the pneumatic tire described above, as illustrated in FIG. 4, the total thickness Gac of the coating layer 23 preferably ranges from 1.5 mm to 3.5 mm. As a result, the effect of improving the communication performance of the transponder 20 can be obtained, and the durability of the transponder can be improved due to the protective effect based on the coating layer 23. Further, specifying the upper limit value of the total thickness Gac of the coating layer 23 allows sufficient durability of the tire to be ensured.

Here, when the total thickness Gac of the coating layer 23 is less than 1.5 mm, the effect of improving the communication performance of the transponder 20 is reduced, and furthermore, the effect of improving the durability of the transponder 20 is reduced since the protective effect based on the coating layer 23 is reduced. On the other hand, when the total thickness Gac of the coating layer 23 is greater than 3.5 m, there is concern that tire durability will degrade. The total thickness Gac of the coating layer 23 is the total thickness of the coating layer 23 at a position including the transponder 20. As illustrated in FIG. 4, for example, the total thickness Gac is the total thickness on a straight line that is perpendicular to a carcass cord of the closest carcass layer 4 and passes through the center C of the transponder 20 on the tire meridian cross-section. The cross-sectional shape of the coating layer 23 is not limited to particular shapes and can adopt, for example, a triangular shape, a rectangular shape, a trapezoidal shape, and a spindle shape.

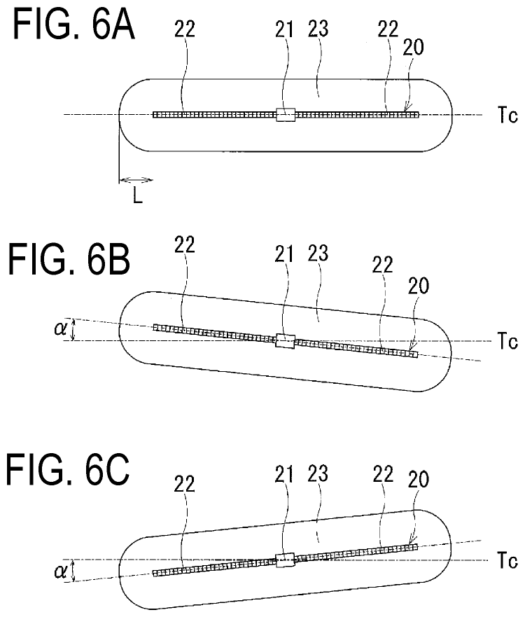

In the pneumatic tire described above, as illustrated in FIGS. 6A to 6C, the transponder 20 includes a substrate 21 and antennas 22 extending from both ends of the substrate 21. The transponder 20 extends along the tire circumferential direction Tc. More specifically, the transponder 20 preferably has an inclination angle α with respect to the tire circumferential direction within a range of ±20°. Further, the distance L between the end of the antenna 22 in the tire circumferential direction and the end of the coating layer 23 in the tire circumferential direction preferably ranges from 2 mm to 20 mm. This reliably covers the entire transponder 20 with the coating layer 23, allowing a sufficient communication distance of the transponder 20 to be ensured. Furthermore, specifying the upper limit value of the distance L avoids occurrence of a local weight increase on the tire circumference and can satisfactorily maintain a tire balance.

Here, when the absolute value of the inclination angle α of the transponder 20 with respect to the tire circumferential direction Tc is greater than 20°, the durability of the transponder 20 decreases with respect to repetitive tire deformation during travel. Further, when the distance L between the end of the antenna 22 in the tire circumferential direction and the end of the coating layer 23 in the tire circumferential direction is smaller than 2 mm, the effect of improving the communication performance of the transponder 20 will be reduced, the end of the antenna 22 in the tire circumferential direction may protrude from the coating layer 23 during travel, the antenna 22 may be damaged, and the communication performance after travel may degrade. On the other hand, even when the distance L is greater than 20 mm, the effect of further improving the communication performance of the transponder 20 cannot be obtained, and thus the tire balance can be degraded due to unnecessary weight increase.

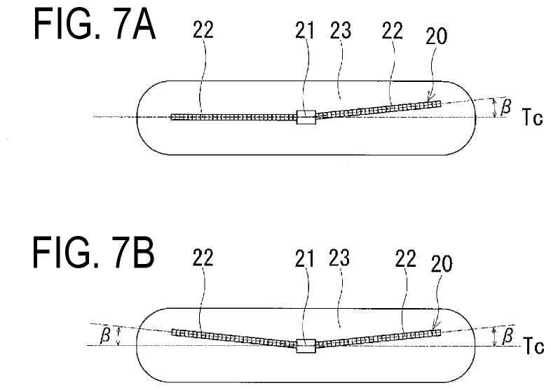

In the pneumatic tire described above, as illustrated in FIGS. 7A and 7B, the transponder 20 may include a substrate 21 and antennas 22 extending from both ends of the substrate 21, and at least one of the antennas 22 may extend so as to bend with respect to the substrate 21. In this case, the angle β of the antennas 22 with respect to the tire circumferential direction Tc is preferably within a range of ±20°. Restricting the inclination of the antenna 22 constituting the transponder 20 in this manner can ensure sufficient durability of the transponder 20.

Here, when the absolute value of the inclination angle β of the transponder 20 with respect to the tire circumferential direction Tc is larger than 20°, stress concentrates on the base end portion of the antenna 22 due to repetitive tire deformation during travel, decreasing the durability of the transponder 20. The antenna 22 is not necessarily straight, and the inclination angle β of the antenna 22 is an angle between a straight line connecting the base end with the tip end of the antenna 22 and the tire circumferential direction Tc.

As the composition of the coating layer 23, the coating layer 23 is preferably made of rubber or elastomer and 20 phr or more of white filler. The relative dielectric constant can be set relatively lower for the coating layer 23 configured as described above than for the coating layer 23 containing carbon, allowing the communication performance of the transponder 20 to be effectively improved. Note that “phr” as used herein means parts by weight per 100 parts by weight of the rubber component (elastomer).

The white filler constituting the coating layer 23 preferably includes from 20 phr to 55 phr of calcium carbonate. This enables a relatively low relative dielectric constant to be set for the coating layer 23, allowing the communication performance of the transponder 20 to be effectively improved. However, the white filler with an excessive amount of calcium carbonate contained is brittle, and the strength of the coating layer 23 decreases. This is not preferable. Additionally, the coating layer 23 can optionally contain, in addition to calcium carbonate, 20 phr or less of silica (white filler) or 5 phr or less of carbon black. In a case where a small amount of silica or carbon black is used with the coating layer 23, the relative dielectric constant of the coating layer 23 can be reduced while ensuring the strength of the coating layer 23.

In addition, the coating layer 23 preferably has a relative dielectric constant of 7 or less and more preferably from 2 to 5. By properly setting the relative dielectric constant of the coating layer 23 as described above, radio wave transmittivity can be ensured during emission of a radio wave by the transponder 20, effectively improving the communication performance of the transponder 20. Note that the rubber constituting the coating layer 23 has a relative dielectric constant of from 860 MHz to 960 MHz at ambient temperature. In this regard, the ambient temperature is 23±2° C. and 60%±5% RH (relative humidity) in accordance with the standard conditions of the JIS (Japanese Industrial Standard) standard. The relative dielectric constant of the rubber is measured by the capacitance method after the rubber is treated at 23° C. and 60% RH for 24 hours. The range from 860 MHz to 960 MHz described above corresponds to currently allocated frequencies of the RFID in a UHF (ultra-high frequency) band, but in a case where the allocated frequencies are changed, the relative dielectric constant in the range of the allocated frequencies is specified as described above.

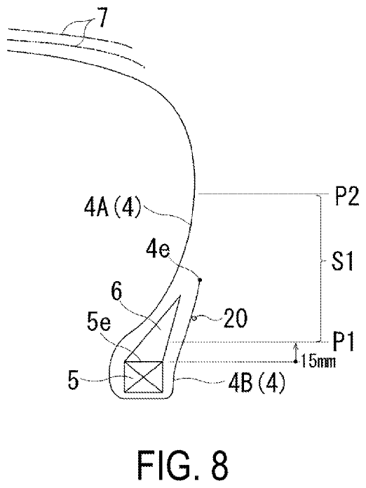

In the pneumatic tire described above, as illustrated in FIG. 8, the transponder 20 is preferably disposed between a position P1 located 15 mm on the outer side in the tire radial direction from an upper end 5e of the bead core 5 (an end portion on the outer side in the tire radial direction) and a position P2 corresponding to the tire maximum width as a placement region in the tire radial direction. In other words, the transponder 20 is preferably disposed in a region 51 illustrated in FIG. 8. In a case where the transponder 20 is disposed in the region 51, the transponder 20 is positioned in a region subjected to a low stress amplitude during travel, thus allowing the durability of the transponder 20 to be effectively improved, and further preventing the communication performance of the transponder 20 and the durability of the tire from being degraded. In this regard, in a case where the transponder 20 is disposed on the inner side of the position P1 in the tire radial direction, the transponder 20 is brought close to a metal member such as the bead core 5 and thus tends to have degraded communication performance. On the other hand, in a case where the transponder 20 is disposed on the outer side in the tire radial direction of the position P2, the transponder 20 is positioned in a region having a larger stress amplitude during travel, leading to a high likelihood of damage to the transponder 20 itself and of an interfacial failure around the transponder 20. This is not preferable. In particular, the transponder 20 is preferably disposed between the position 20 mm on the outer side in the tire radial direction from the upper end 5e of the bead core 5 and the upper end of the bead filler 6 or between the position 20 mm on the outer side in the tire radial direction from the upper end 5e of the bead core 5 and the position 40 mm on the outer side in the tire radial direction from the upper end 5e of the bead core 5 as the placement region in the tire radial direction. In this case, both the communication performance of the transponder 20 and the durability of the tire can be achieved at a high level.

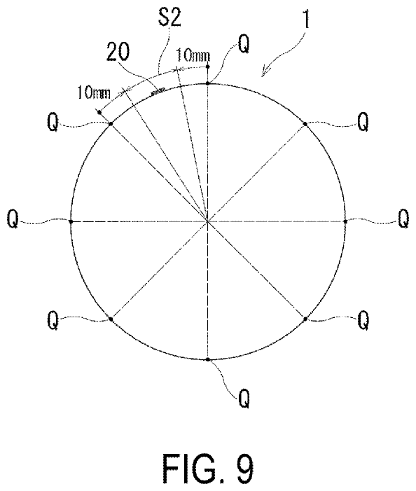

As illustrated in FIG. 9, a plurality of splice portions formed by overlaying end portions of the tire component are on the tire circumference. FIG. 9 illustrates positions Q of the respective splice portions in the tire circumferential direction. The center of the transponder 20 is preferably disposed 10 mm or more spaced from the splice portion of the tire component in the tire circumferential direction. In other words, the transponder 20 is preferably disposed in a region S2 illustrated in FIG. 9. Specifically, the IC substrate 21 constituting the transponder 20 is preferably located 10 mm or more spaced from the position Q in the tire circumferential direction. Furthermore, the entire transponder 20 including the antenna 22 is more preferably located 10 mm or more spaced from the position Q in the tire circumferential direction, and the entire transponder 20 covered with the coating rubber is most preferably located 10 mm or more spaced from the position Q in the tire circumferential direction. Moreover, the tire component in which the splice portion is disposed spaced from the transponder 20 is preferably a member adjacent to the transponder 20. Examples of such a tire component include the carcass layer 4, the bead filler 6, the innerliner layer 9, the sidewall rubber layer 12, and the rim cushion rubber layer 13. Disposing the transponder 20 at a position spaced from the splice portion of the tire component can effectively improve the durability of the tire.

More specifically, when the transponder 20 is disposed between the carcass layer 4 and the innerliner layer 9, the splice portion of the carcass layer 4 and/or the splice portion of the innerliner layer 9 is preferably disposed spaced from the transponder 20. When the transponder 20 is disposed between the carcass layer 4 and one of the sidewall rubber layer 12 and the rim cushion rubber layer 13 and the carcass layer 4 has a low turn-up structure, the splice portion of the bead filler 6 and/or the splice portion of one of the sidewall rubber layer 12 and the rim cushion rubber layer 13 is preferably disposed spaced from the transponder 20 located on the inner side in the tire radial direction from the vertex of the bead filler 6, and the splice portion of the carcass layer 4 and/or the splice portion of one of the sidewall rubber layer 12 and the rim cushion rubber layer 13 is preferably disposed spaced from the transponder 20 located in the flex zone on the outer side in the tire radial direction from the vertex of the bead filler 6. When the transponder 20 is disposed between the carcass layer 4 and one of the sidewall rubber layer 12 and the rim cushion rubber layer 13, and the carcass layer 4 has a high turn-up structure, the splice portion of the carcass layer 4 and/or the splice portion of one of the sidewall rubber layer 12 and the rim cushion rubber layer 13 is preferably disposed spaced from the transponder 20.

Note that in the embodiment of FIG. 9, an example in which the positions Q of the splice portions of each tire component in the tire circumferential direction are disposed at equal intervals, but no such limitation is intended. The position Q in the tire circumferential direction can be set at any position, and in either case, the transponder 20 is disposed 10 mm or more spaced from the splice portion of each tire component in the tire circumferential direction.

In the example illustrated in the embodiment described above, the end 4e of the turned-up portion 4B of the carcass layer 4 is disposed close to the upper end 6e of the bead filler 6. However, no such limitation is intended, and the end 4e of the turned-up portion 4B of the carcass layer 4 can be disposed at any height.

### Examples

Tires according to Comparative Example 1 and Examples 1 to 15 were manufactured. The tires were each a pneumatic tire having a tire size of 235/60R18 and including a tread portion extending in the tire circumferential direction and having an annular shape, a pair of sidewall portions respectively disposed on both sides of the tread portion, and a pair of bead portions each disposed on the inner side of the pair of sidewall portions in the tire radial direction. In the pneumatic tire, a columnar transponder was embedded in one of the sidewall portions on the outer side in the tire width direction of the carcass layer extending in the tire circumferential direction, and the transponder was covered with a coating layer. The shortest distance D from the outer edge of the coating layer to the transponder in the tire meridian cross-section, the total thickness Gac of the coating layer, the distance L between the end of the antenna in the tire circumferential direction and the end of the coating layer in the tire circumferential direction, the relative dielectric constant of the coating layer, the distance in the tire circumferential direction from the transponder center to the splice portion of the tire component, and the position of the transponder in the tire radial direction were set as shown in Tables 1 and 2.

In Comparative Example 1 and Examples 1 to 15, the relative dielectric constant of the coating layer is lower than that of the peripheral rubber member.

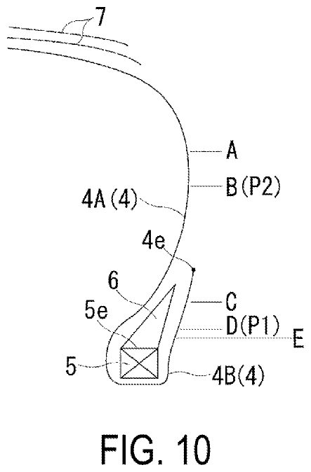

In Tables 1 and 2, the position of the transponder in the tire radial direction corresponds to each of the positions A to E illustrated in FIG. 10.

Tire evaluation (durability) and transponder evaluation (communication performance and durability) were conducted on the test tires using a test method described below, and the results are indicated in Tables 1 and 2. Communication Performance (transponder):

For each test tire, a communication operation with the transponder was performed using a reader/writer. Specifically, the maximum communication distance was measured with the reader/writer at a power output of 250 mW and a carrier frequency of from 860 MHz to 960 MHz. The evaluation results are expressed as three levels: “Excellent” indicates that the communication distance was 1000 mm or more, “Good” indicates that the communication distance was 500 mm to 1000 mm, and “Fair” indicates that the communication distance was less than 500 mm.

### Durability (Tire and Transponder):

Each of the test tires was mounted on a wheel of a standard rim, and a traveling test was performed by using a drum testing machine at an air pressure of 120 kPa, a maximum load of 102%, and a traveling speed of 81 km/h, and the traveling distance at the time of a failure in the tire was measured. The evaluation results are expressed as three levels: “Excellent” indicates that the traveling distance reached 6480 km, “Good” indicates that the traveling distance was 4050 km to 6480 km, and “Poor” indicates that the traveling distance was less than 4050 km. Furthermore, after the end of traveling, each test tire was checked for the availability of communication of the transponder and for damage to the transponder. Results are expressed as two levels: “Good” indicates that communication was enabled and no damage was found (as new as new products), and “Fair” indicates that communication was enabled but the communication distance has decreased due to damage to the antenna.

TABLE 1-1

| | | Compar- | | | |
|---|---|---|---|---|---|
| | | ative | Exam- | Exam- | Exam- |
| | | Exam- | ple | ple | ple |
| | | ple 1 | 1 | 2 | 3 |
| Shortest distance D from | | 0.2 | 0.3 | 0.3 | 0.3 |
| outer edge of coating layer | | | | | |
| to transponder coating layer | | | | | |
| (mm) | | | | | |
| Total thickness Gac of | | 1.0 | 1.0 | 1.5 | 2.0 |
| coating layer (mm) | | | | | |
| Distance L (mm) | | 10 | 10 | 10 | 10 |
| Relative dielectric constant | | 8 | 8 | 8 | 8 |
| of coating layer | | | | | |
| Distance from transponder | | 10 | 10 | 10 | 10 |
| center to splice portion | | | | | |
| (mm) | | | | | |
| Position of transponder in | | C | C | C | C |
| tire radial direction | | | | | |
| Tire | Durability | Excel- | Excel- | Excel- | Excel- |
| evaluation | | lent | lent | lent | lent |
| Transponder | Communication | Fair | Good | Excel- | Excel- |
| evaluation | performance | | | lent | lent |
| | Durability | Fair | Fair | Good | Good |

TABLE 1-2

| | | Example | Example | Example | Example |
|---|---|---|---|---|---|
| | | 4 | 5 | 6 | 7 |
| Shortest distance D from | | 0.3 | 0.3 | 0.3 | 0.3 |
| outer edge of coating layer | | | | | |
| to transponder coating layer | | | | | |
| (mm) | | | | | |
| Total thickness Gac of | | 3.5 | 4.0 | 2.0 | 2.0 |
| coating layer (mm) | | | | | |
| Distance L (mm) | | 10 | 10 | 1.0 | 2.0 |
| Relative dielectric constant | | 8 | 8 | 8 | 8 |
| of coating layer | | | | | |
| Distance from transponder | | 10 | 10 | 10 | 10 |
| center to splice portion | | | | | |
| (mm) | | | | | |
| Position of transponder in | | C | C | C | C |
| tire radial direction | | | | | |
| Tire | Durability | Good | Good | Good | Good |
| evaluation | | | | | |
| Transponder | Communication | Excellent | Excellent | Good | Excellent |
| evaluation | performance | | | | |
| | Durability | Good | Good | Fair | Good |

TABLE 2-1

| | | Exam- | Exam- | Exam- | Exam- |
|---|---|---|---|---|---|
| | | ple | ple | ple | ple |
| | | 8 | 9 | 10 | 11 |
| Shortest distance D from | | 0.3 | 0.3 | 0.3 | 0.3 |
| outer edge of coating layer | | | | | |
| to transponder (mm) | | | | | |
| Total thickness Gac of | | 2.0 | 2.0 | 1.0 | 2.0 |
| coating layer (mm) | | | | | |
| Distance L (mm) | | 20 | 30 | 10 | 10 |
| Relative dielectric constant | | 8 | 8 | 7 | 7 |
| of coating layer | | | | | |
| Distance from transponder | | 10 | 10 | 10 | 5 |
| center to splice portion | | | | | |
| (mm) | | | | | |
| Position of transponder in | | C | C | C | C |
| tire radial direction | | | | | |
| Tire | Durability | Good | Good | Excel- | Good |
| evaluation | | | | lent | |
| Transponder | Communication | Excel- | Excel- | Excel- | Excel- |
| evaluation | performance | lent | lent | lent | lent |
| | Durability | Good | Good | Fair | Good |

TABLE 2-2

| | | Exam- | Exam- | Exam- | Exam- |
|---|---|---|---|---|---|
| | | ple | ple | ple | ple |
| | | 12 | 13 | 14 | 15 |
| Shortest distance D from | | 0.3 | 0.3 | 0.3 | 0.3 |
| outer edge of coating layer | | | | | |
| to transponder (mm) | | | | | |
| Total thickness Gac of | | 2.0 | 2.0 | 2.0 | 2.0 |
| coating layer (mm) | | | | | |
| Distance L (mm) | | 10 | 10 | 10 | 10 |
| Relative dielectric constant | | 7 | 7 | 7 | 7 |
| of coating layer | | | | | |
| Distance from transponder | | 10 | 10 | 10 | 10 |
| center to splice portion | | | | | |
| (mm) | | | | | |
| Position of transponder in | | E | D | B | A |
| tire radial direction | | | | | |
| Tire | Durability | Excel- | Excel- | Excel- | Good |
| evaluation | | lent | lent | lent | |
| Transponder | Communication | Good | Excel- | Excel- | Excel- |
| evaluation | performance | | lent | lent | lent |
| | Durability | Good | Good | Good | Good |

As can be seen from Tables 1 and 2, the pneumatic tires of Examples 1 to 15 were able to improve the communication performance of the transponder as compared to Comparative Example 1. In Comparative Example 1, since D=0.2, the communication performance of the transponder was not sufficient.

1. A pneumatic tire, comprising:
a tread portion extending in a tire circumferential direction and having an annular shape;
a pair of sidewall portions respectively disposed on both sides of the tread portion; and
a pair of bead portions each disposed on an inner side of the pair of sidewall portions in a tire radial direction;
a transponder being embedded in one of the sidewall portions extending in the tire circumferential direction, the transponder being covered with a coating layer, a relative dielectric constant of the coating layer being lower than a relative dielectric constant of a peripheral rubber member adjacent to the coating layer, and a shortest distance D from an outer edge of the coating layer to the transponder in a tire meridian cross-section being 0.3 mm or more.

2. The pneumatic tire according to claim 1, wherein a total thickness Gac of the coating layer ranges from 1.5 mm to 3.5 mm.

3. The pneumatic tire according to claim 1, wherein
the transponder comprises a substrate and antennas extending from both ends of the substrate, and
a distance L between an end of the antenna in the tire circumferential direction and an end of the coating layer in the tire circumferential direction ranges from 2 mm to 20 mm.

4. The pneumatic tire according to claim 1, wherein the coating layer is made of elastomer or rubber and has a relative dielectric constant of 7 or less.

5. The pneumatic tire according to claim 1, wherein a center of the transponder in a length direction is disposed 10 mm or more spaced from a splice portion of a tire component in the tire circumferential direction.

6. The pneumatic tire according to claim 1, wherein the transponder is disposed between a position of 15 mm outer side in the tire radial direction from an upper end of a bead core of one of the bead portions and a tire maximum width position.

7. The pneumatic tire according to claim 2, wherein
the transponder comprises a substrate and antennas extending from both ends of the substrate, and
a distance L between an end of the antenna in the tire circumferential direction and an end of the coating layer in the tire circumferential direction ranges from 2 mm to 20 mm.

8. The pneumatic tire according to claim 7, wherein the coating layer is made of elastomer or rubber and has a relative dielectric constant of 7 or less.

9. The pneumatic tire according to claim 8, wherein a center of the transponder in a length direction is disposed 10 mm or more spaced from a splice portion of a tire component in the tire circumferential direction.

10. The pneumatic tire according to claim 9, wherein the transponder is disposed between a position of 15 mm outer side in the tire radial direction from an upper end of a bead core of one of the bead portions and a tire maximum width position.
